(19) United States
(12) Patent Application Publication
(10) Pub. No.: US 2007/0045414 A1
(43) Pub. Date: Mar. 1, 2007

(54) Arrangement for detection of storage units

(76) Inventors: Wilfried Diesler, Gauting (DE); Ralf Ubert, Erding (DE)

Correspondence Address: SCHIFF HARDIN, LLP;PATENT DEPARTMENT, 6600 SEARS TOWER, CHICAGO, IL, 60606-6473, US

(21) Appl. No.: 11/353,372

(22) Filed: Feb. 13, 2006

(30) Foreign Application Priority Data
Sep. 1, 2005 (DE) 20 2005 013 842.8

(51) Int. Cl. G06Q 30/00

(52) U.S. Cl. 235/385

(57) ABSTRACT

In an arrangement and method for identification and association of a quantity of shipping packages supplied to a postal sortation site, an electronic data memory that can be read without contact and that has at least one memory region in which at least data for individual identification of the medium are stored is associated with multiple shipping packages. Each data medium is associated with one of at least two groups. At least the data stored in the memory region of the respective data medium regarding its individual identification are acquired with a reader. The respective data medium is identified with the acquired data. At least an acquisition process of the identified data of the data medium is registered. At least a number of the shipping packages supplied to the sortation site for a predetermined all time span is determined for at least one of the groups with aid of the registered acquisition processes.

### BACKGROUND

The preferred embodiment concerns an arrangement for determination and association of the quantity of shipping packages supplied to a sortation site. Multiple shipping packages respectively comprise an electronic data medium that can be read without contact, with at least one memory region in which at least data for individual identification of the data medium are stored. Every data medium is associated with one of at least two groups. The arrangement comprises a reader for detection of at least the data stored in the memory region of the respective data medium regarding its individual identification.

The preferred embodiment also concerns an arrangement for hierarchical archiving of storage units. Multiple storage units are provided in which respectively at least one object to be archived is contained, whereby each of the first storage units comprises an electronic data medium that can be read without contact, in whose memory region at least data for individual identification of the respective data medium are stored and with which a first identifier of a first hierarchy is associated. Multiple second storage units are respectively provided for acceptance of a first storage unit or a plurality of first storage units, whereby the second storage units respectively comprise an electronic data medium that can be read without contact. The arrangement also comprises a reader for non-contact reading of at least the data stored in the respective data medium regarding its individual identification.

Electronic data media that can be read without contact and that contain a memory region in which data can be stored are known for object identification. Such data media are also designated as RFID transponders, RFID markers, RFID labels or RFID tags. Various embodiments of such RFID transponders are known. In a simple embodiment, an RFID transponder has a unique identifier that can be read without contact and without intervisibility with the aid of a suitable reader, whereby further information that are associated with this unique identifier of the RFID transponder are determined from a databank with the aid of this identifier. Other RFID transponders have a memory region in which further, advantageously individual data can be stored that are then read with the aid of the reader. Other RFID transponders have memory regions that can also be written without contact and without intervisibility with the acoustic input signal of a write device such that arbitrary data can be stored in these memory regions. Combined readers and writers are then advantageously provided. Dependent on the RFID transponder type, the reading and/or writing occurs inductively at low frequencies via a near field or alternatively at higher frequencies via an electromagnetic far field. A preferred embodiment of such RFID transponders are RFID transponder circuits arranged on a self-adhesive film. The self-adhesive films with the RFID transponders can then be adhered to objects. Other advantageous embodiments of RFID transponders combine the transponder circuit with writeable and printable tags such as, for example, self-adhesive paper labels.

RFID transponders are, for example, used for monitoring of postal shipments. This is, for example, known from the documents DE 197 20 747 A and U.S. Pat. No. 6,738,689 B2. Methods and device systems for generation and tracking of printed documents are known from the document WO 03/0977196 A1, in which a unique identifier that is stored in an RFID transponder connected with the document is associated with each document. Arrangements and methods for shipment tracking, advantageously for monitoring of a supply chain, are known from the documents EP 1 189 163 A2, U.S. Pat. Nos. 6,843,415 B2, 2003/0227392 A1. Hierarchical organization structures for organization of objects connected with RFID tags are known from the document WO 2004/102330 A2 and from the document “Cascading RFID-Tags”, Jeffrey D. Lindsay and Walter Ready, Nov. 7, 2003, http://www.jefflindsay.com/rfid3.shtml. The content of the cited documents (in particular the RFID transponder technology described there, the infrastructure for reading and writing the RFID transponders and the infrastructure for administration of the read data and the data to be written) is herewith incorporated by reference into the disclosure of the present specification.

### SUMMARY

It is an object to specify an arrangement that, in a simple manner, determines the quantity of the shipping packages delivered to a sortation site. Furthermore, it is an object to specify an arrangement in which a hierarchical archiving of storage units is possible in a simple manner.

In an arrangement and method for identification and association of a quantity of shipping packages supplied to a postal sortation site, an electronic data memory that can be read without contact and that has at least one memory region in which at least data for individual identification of the medium are stored is associated with multiple shipping packages. Each data medium is associated with one of at least two groups. At least the data stored in the memory region of the respective data medium regarding its individual identification are acquired with a reader. The respective data medium is identified with the acquired data. At least an acquisition process of the identified data of the data medium is registered. At least a number of the shipping packages supplied to the sortation site for a predeterminable time span is determined for at least one of the groups with aid of the registered acquisition process.

### BRIEF DESCRIPTION OF THE DRAWINGS

FIG. 1 is a schematic design of an arrangement for determination and association of the quantity of postal bags delivered to a postal sortation site;

FIG. 2 is a schematic representation of the data flow of the arrangement according to FIG. 1;

FIG. 3 shows institutions participating in the identification and tracking of the postal bags supplied to the postal sortation site according to FIG. 1;

FIG. 4 shows the processes participating in the determination and association of the postal bags supplied to the sortation site according to FIG. 1;

FIG. 5 is a schematic representation of a system for hierarchical archiving of storage units; and

FIG. 6 shows the institutions participating in the system for hierarchical archiving of storage units according to FIG. 5.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

Via an arrangement of the preferred embodiment, it is achieved that the shipping packages can be identified and associated with one of the preset groups in a simple manner. Due to the association of each shipping package with a group, the number of the shipping packages to be associated with each group can be detected in a simple manner. For example, the number of the shipping packages that originate from a sender and/or that are to be associated with a specific cost center can be determined via the group association.

Due to an arrangement for hierarchical archiving of storage units, it can be monitored in a simple manner whether the first storage unit associated with an external second storage unit is actually contained within the second storage unit. Such a monitoring can be implemented given stocking of the second storage unit in an archive or given removal of the second storage unit from the archive, whereby a large degree of transparency of the storage units contained in the archive and removed from the archive is achieved. In a development of the preferred embodiment, the removal and/or stocking of the second storage unit can be limited to one person or one personnel group that must be correspondingly identified before the stocking or removal of the second storage unit. The risk of accidental or improper incorrect stockings and/or removals can thereby be further reduced.

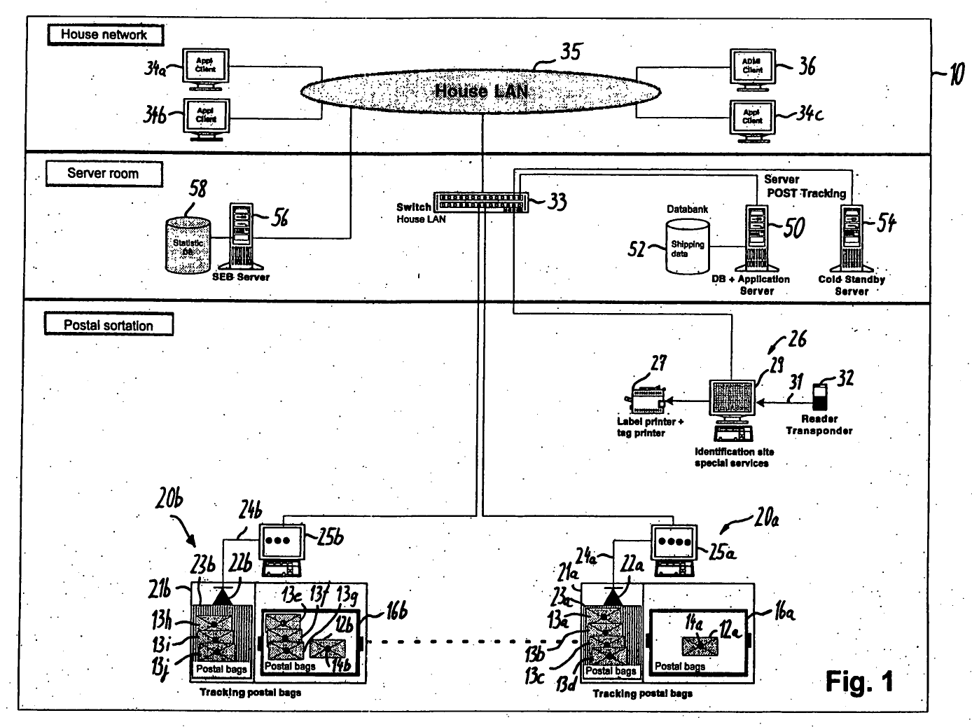

The design of an arrangement for determination and association of the quantity of postal bags 12a, 12b, 13a through 13j is schematically shown in FIG. 1. The postal sortation site 10 has two identification stations 20a, 20b that respectively have a reader 22a, 22b integrated into an identification table 21a, 21b as well as an identification computer 25a, 25b connected with the respective reader 22a, 22b via a data connection 24a, 24b. The postal bags respectively contain an RFID transponder. The RFID transponders of the postal bags 12a and 12b are designated with 14a or with 14b. At least the identification information of the RFID transponders supplied to an identification region 23a, 23b of the respective reader 22a, 22b are respectively read out with the aid of the readers 22a, 22b, whereby this information is subsequently transferred to the identification computer 25a, 25b connected with the respective reader 22a, 22b. Given a bulk read event, data are read nearly simultaneously from the memory regions of all RFID transponders located in the identification region 23a, 23b of the respective reader 22a, 22b during one read cycle.

The postal sortation site 10 also has a special identification location 26 that comprises an identification computer 29, a reader 23 and a label printer 27. The reader 32 is connected with the identification computer 29 via a data line 31, and the label printer 27 is connected with the identification computer 29 via a data line 28.

In the same manner as the readers 23a, 23b, the reader 32 serves for reading of the data stored in a memory region of an RFID transponder. The label printer 27 serves for printing of a printable surface of a tag or label. An RFID transponder is respectively contained in a label. Between a printable front side and a back side, the label advantageously has a foamed intermediate layer in which is contained the RFID transponder comprised of a transponder circuit and at least one antenna coil. The RFID transponder is advantageously integrated into the label such that the front side and the back side of the label exhibit no unevenness caused by the RFID transponder. Such a label is designated in the following as a transponder tag or as a transponder label. In particular a unique serial number of the transponder that serves as identification information is stored in each transponder tag. The transponder is advantageously a passive transponder that requires no energy supply of its own for readout of the data stored in a memory region of the transponder. The energy required for readout of the data from the memory range is advantageously induced via the antenna of the transponder by the reader 22a, 22b, 32.

Further information (such as, for example, the sender of the postal bag 12a; 12b, 13a through 13j; the receiver of the postal bag 12a, 12b, 13a through 13j; the shipping type of the shipments contained in the postal bag 12a, 12b, 13a through 13j; the weight of the shipments contained in the postal bag 12a, 12b, 13a through 13j; as well as time specifications of points of time at which the postal bag 12a, 12b, 13a through 13j has passed monitoring points) can be stored at least temporarily in further memory regions of the transponder. For example, remittance slips (bank transfer slips), checks, enveloped internal business postal shipments and enveloped postal shipments that are designated for external receivers can be contained in the postal bags 12a, 12b, 13a through 13j, depending on the shipment type for which the respective postal bag 12a, 12b, 13a through 13j is specified. The postal bag 12a, 12b, 13a through 13j is advantageously transported from a sender (such as, for example, a corporate site or a branch office) to the postal sortation site 10 in a container 16a, 16b, advantageously with further postal bags 12a, 12b, 13a through 13j. For transport, the container 16a, 16b is transferred to a postal service or a courier service that transports the container 16a, 16b from the corporate site or the branch office to the postal sortation site 10.

The identification computers 25a, 25b, 26 are connected via a network switch 33 with servers 50, 54 as well as with an internal local area network 35 of the postal sortation site 10. The server 50 processes a databank application for provision of a databank 52. The server 54 is what is known as a cold standby server that, upon failure of the server 50, takes on its function. Data can be transferred over the local area network 35 between application clients 34a, 34b, 34c connected with the local area network 35, an administrator client 36 connected with the local area network 35 and the servers 50, 54 as well as a further server 56. A statistic databank 58 is provided with the aid of the server 56. In particular data can be transferred over the local area network 35 between the server 56 and the servers 50, 54, whereby the server 50 can at least read the data stored in the databank 58 and the server 56 can at least read data stored in the databank 52.

A new transponder tag for a postal bag 12a, 12b, 13a through 13j is generated and registered in the databank 52 with the aid of the identification site 26. For registration, a data set associated with the new transponder tag to be registered is generated in the databank 52, in which data set are stored the identification data of the transponder tag as well as information of the shipment type associated with the transponder tag and the sender information and receiver information associated with the transponder tag with the aid of the identification computer 29. Data fields for storage of the delivery times of the transponder tag or of the postal bag 12a, 12b, 13a through 13j containing the transponder tag in the postal sortation site 10 and a data field for counting or metering for storage of a count value are also provided in the data set. The count value specifies how often the same postal bag 12a, 12b, 13a through 13j has arrived at the postal sortation site 10 with documents to be forwarded. This count value is deleted after the count value has been read out for further processing for billing and/or statistical purposes after a preset span of time. All delivery times of the transponder tag in a preset time span are advantageously stored in the databank 52 and/or the databank 58.

Sender information and receiver information are printed on one side or on both sides of the transponder tag with the aid of the printer 27. This sender information and receiver information coincide with the sender information and receiver information stored in the databank 52 regarding the respective transponder tag. Transponder tags with various background colors are provided, whereby a different shipping type is associated with each background color. A further reader that reads at least the identification information of the transponder of a transponder tag to be printed before and/or after the printing is advantageously integrated into the printer 27. It can thereby be checked whether the transponder tag that should be directly printed has actually been supplied to the printer 27.

A transponder tag printed with the aid of the printer 27 and registered with the aid of the identification computer 29 in the databank 52 is inserted into a tag pocket of the postal bag 12a, 12b, 13a; through 13j provided for this and secured in this via sealing of the tag pocket. After the insertion of the transponder tag into the tag pocket, the information printed on the transponder tag is arranged such that it can be easily read from the outside. The data stored in the transponder tag can also be read without contact and without intervisibility between reader 22a, 22b, 32 and the transponder tag, such that the transponder tag can remain in the tag pocket of the postal bag 12a, 12b, 13a through 13j for reading. Both a sender and a receiver are associated in a fixed manner with the postal bag 12a, 12b, 13a through 13j due to the inserted transponder tag, whereby the postal bag 12a, 12b, 13a through 13j is sent back to the sender after delivery to the receiver. The sender can then use this same postal bag 12a, 12b, 13a through 13j with the same transponder tag to resend shipments to the same receiver. Data (in particular information about the shipment type, the sender and the receiver) can additionally be written into a memory region of the respective transponder tag with the aid of a writer at the identification site 26 and/or the identification sites 20a, 20b.

At the postal sortation site 10, the postal bags 12a, 12b, 13a through 13j are collected, advantageously with further postal bags 12a, 12b, 13a through 13j addressed to the same receiver, in a container 16a, 16b addressed to this receiver and sent to this receiver. Alternatively, the shipments contained in the postal bags 12a, 12b, 13a through 13j are extracted from the postal bag 12a, 12b, 13a through 13j and transported further to a receiver. The transponder tags of the postal bags 12a, 12b, 13a through 13j supplied to the postal sortation site 10 are already registered in the databank 52 as described and can thus be uniquely identified with the aid of the identification information stored in a memory region of the respective transponder tag.

The data stored in the transponder tags are read out by the reader 22a, 22b of the identification table 21a, 21b and transferred to the identification computer 25a, 25b connected with the reader 22a, 22b. The identification computer 25a, 25b processes these data and outputs information to a display unit regarding the postal bag 12a, 12b, 13a through 13j identified with the aid of the identification information of the transponder tag. The output information can thus be verified by an operating personnel. The identification computer 25a, 25b in particular outputs an error message when no databank entry in the databank 52 can be associated with the data read from the transponder tag. If that is the case, as already described this transponder tag must be registered with the aid of the identification unit 26. The point in time of the identification of the read data is stored as a delivery time in the data set that is associated in the databank 52 with the identified transponder tag or the identified postal bag 12a, 12b, 13a through 13j.

With the aid of the sender data, the statistic server 56 determines the number of the postal bags 12a, 12b, 13a through 13j originating through the identification units 20a, 20b from one sender that have been distributed via the postal sortation site 10 in a preset time span, for example one calendar month. This number is advantageously partitioned into shipment types. Different costs can thereby be associated with each shipment type. The identification for the distribution and forwarding of the postal bags 12a, 12b, 13a through 13j and/or the shipments contained in the postal bags 12a, 12b, 13a through 13j can thereby be associated with a sender, such that the costs that are accounted to this sender can be simply and clearly determined.

In one embodiment, multiple counters can be associated with a sender for identification of the number of postal bags 12a, 12b, 13a through 13j to be accounted to a sender, whereby multiple identification groups are provided with which a counter is respectively associated. The identification groups can respectively be associated with various senders, cost centers and/or shipment types. With the aid of the statistic server 56, the history (i.e. the path and the changes of the postal bag appearance that arrives from a sender at the postal sortation site 10 and/or is forwarded to a receiver) can be analyzed and be output with the aid of suitable representation methods (or alternatively as data).

At least one group association of the transponder tag or of the postal bag 12a, 12b, 13a through 13j associated with this transponder tag with one group (of at least two groups that are different from one another) is stored in the data set associated with each transponder tag in the databank 52. A different sender is associated with each group. For group association, a sender associated with this transponder tag is permanently stored in the data set of each transponder tag that is stored in the databank 52. The number of the senders advantageously corresponds to the number of the groups. The group thus does not necessarily have to be stored in the transponder tag itself. Alternatively, a different cost center can be assigned to each group, whereby a predetermined cost center is associated with the transponder tag. Information about the cost center associated with the transponder tag is stored in the data set of the transponder tag in the databank 52,

Alternatively, at least the sender, the receiver, the cost center and/or the shipping type are stored encrypted in the identification information of the RFID transponder tag or as additionally-stored data in the transponder tag. This information can thereby also simply be determined without access to the databank 52.

In the described exemplary embodiment, the containers 16a, 16b contain no RFID transponders or transponder tags. In other exemplary embodiments, the containers 16a, 16b can also contain an RFID transponder that is read with the aid of the reader of the identification table 18 or with a further identification device upon arrival of the container 16 at the postal sortation site 10. A sender and/or a cost center is advantageously associated with the container 16a, 16b, such that the costs arising for the transport of the container 16a, 16b to the postal sortation site 10 can also be associated with the sender or the cost center in a simple manner.

The postal bags 12a, 12b, 13a through 13j leaving the postal sortation site 10 are also advantageously identified with the aid of a reader, in particular with the aid of the readers 22a, 22b of the identification sites 20a, 20b. The identification point in time is stored as a transfer time in the databank 52. In a sortation process, a postal bag 12a, 12b, 13a through 13j is only accounted for once given the statistical identification of the quantity of the postal bags 12a, 12b, 13a through 13j that is sorted by the postal sortation site 10 and that is associated with a sender or a cost center.

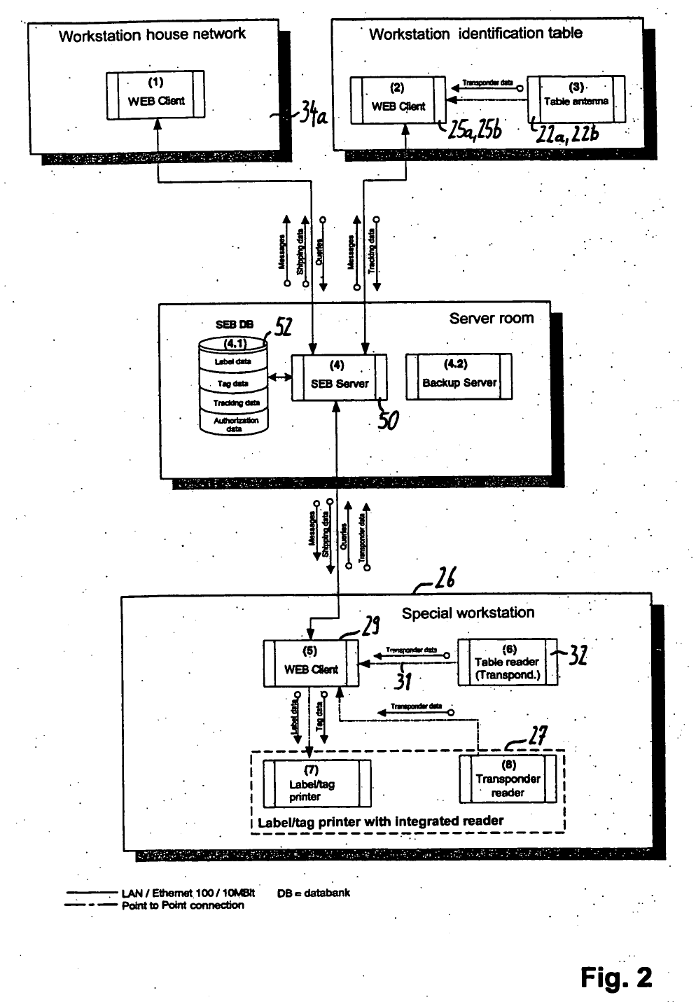

A schematic representation of the data flow of the postal sortation site 10 according to FIG. 1 is shown in FIG. 2. Data read from an RFID transponder tag with the aid of the reader 22a, 22b is transferred from the identification table 21a, 21b of the identification site 20a, 20b to the identification computer 25a, 25b with the aid of a point-to-point connection 24a, 24b on which a user interface provided by the server 50 is displayed with the aid of what is known as a web client. With the aid of this user interface, information provided by the server 50 regarding the postal bags 12a, 12b, 13a through 13j identified with the aid of the reader 21a, 21b is displayed as messages.

The server 50 likewise provides user interfaces for a plurality of application clients 34a through 34c (of which the application client 34a is shown in FIG. 2), which user interfaces can be displayed with the aid of a browser program module via the respective application clients 34a through 34c or with the aid of the administrator client 36. For this, queries (in particular databank queries) can be transferred from a client 34a through 34c, 36 to the server 50. Shipping data are transferred from the server 50 to the application client 34a. Messages are also transferred from the server 50 to the application client 34a over the local area network 35. A further remotely-arranged client can also access the user interface and the data of the server 50 in the same manner as with the aid of the application client 34a, which remotely-arranged client is, for example, connected with the server 50 with the aid of a virtual private network connection (VPN connection) over a wide area network. The server 50 is also connected with the identification unit 26 over a local area network connection. An identification computer 29 of the identification unit 26 is connected with a reader 32 of an identification table in the same manner as the identification computer 25a, 25b of the identification units 20a, 20b. The data read out from a transponder tag with the aid of the reader 32 are transferred to an identification computer 29 over a point-to-point data connection. With the aid of a browser program module, the identification computer outputs a user interface provided by the server 50. Messages and shipment data are transferred to the identification computer 29 from the server 50 in addition to data for generation of the user interface. Queries and data read out from the transponder tags supplied to the reader 32 are transferred from the identification computer 29 to the server 50. The identification computer 29 is furthermore connected with the label printer or the tag printer 27 over a point-to-point data connection. The printer 27 contains a transponder reader. This reader is likewise connected with the identification computer 29 over a second point-to-point data connection. The two point-to-point data connections between the identification computer 29 and the printer 27 with integrated reader can be realized with the aid of a physical data line 28. Label data and tag data and the data read out (by the transponder reader provided in the printer 27) from a transponder tag to be printed are transferred from the identification computer 29 to the printer 27.

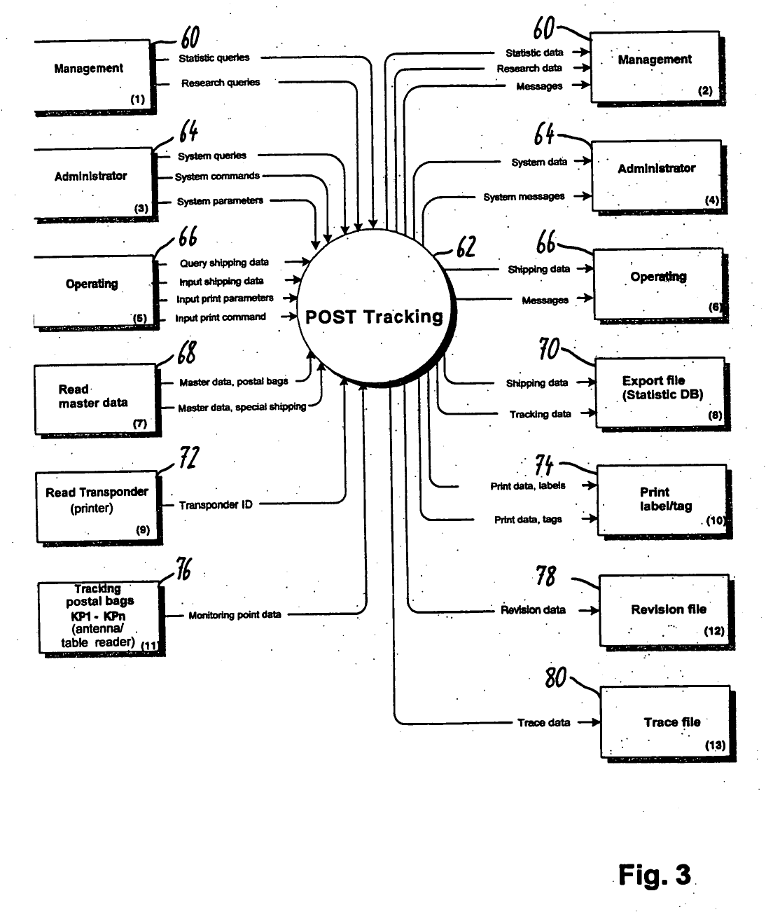

Various institutions are shown in FIG. 3 as block representations for identification and tracking of the postal bags 12a, 12b, 13a through 13j. A management institution 60 generates statistical queries and investigation queries at a monitoring system 62. This transfers statistical data and investigation data to the management institution 60. The monitoring system 62 also transfers information to the management institution 60 with messages. An administrator institution 64 generates system queries and system commands and transfers these, as well as system parameters, to the monitoring system 62. The monitoring system 62 transfers system data and system messages to the administrator institution 64. An operating institution 66 generates queries for shipping data and transfers these as well as input shipping data, input printing parameters and input printing commands to the monitoring system 62. The monitoring system 62 transfers shipping data as well as messages to the operating institution 66.

Master data are transferred from postal bags 12a, 12b, 13a through 13j and special shipping objects to the monitoring system 62 with the aid of an input institution 68 for master data. The monitoring system 62 transfers shipping data and follow-up data in an export file 70 that is provided by the statistic databank 48 of the server 56. Transponder identification data that were read from a transponder tag with the aid of the transponder reader integrated into the printer 27 are also transferred from a transponder read institution 72 to the monitoring system 62. The identification data of the transponder tag are also designated as a transponder ID. The monitoring system 62 transfers print data for printing of labels and print data for printing of tags to a printing institution 74 that prints transponder tags and labels with the aid of the printer 27. With the help of a follow-up institution 76, transponder IDs read at monitoring points KP1 through KPn are identified and the transponders or the postal bags 12a, 12b, 13a through 13j are identified with the aid of the monitoring points. The follow-up institution 76 transfers monitoring point data to the monitoring system 62. The monitoring system 62 transfers revision data to a revision institution 78, which revision data are stored in a revision file. The monitoring system 62 also transfers data for follow-up (what are known as trace data) to a process (workflow) tracking institution 80, whereby the trace data are stored in a trace file.

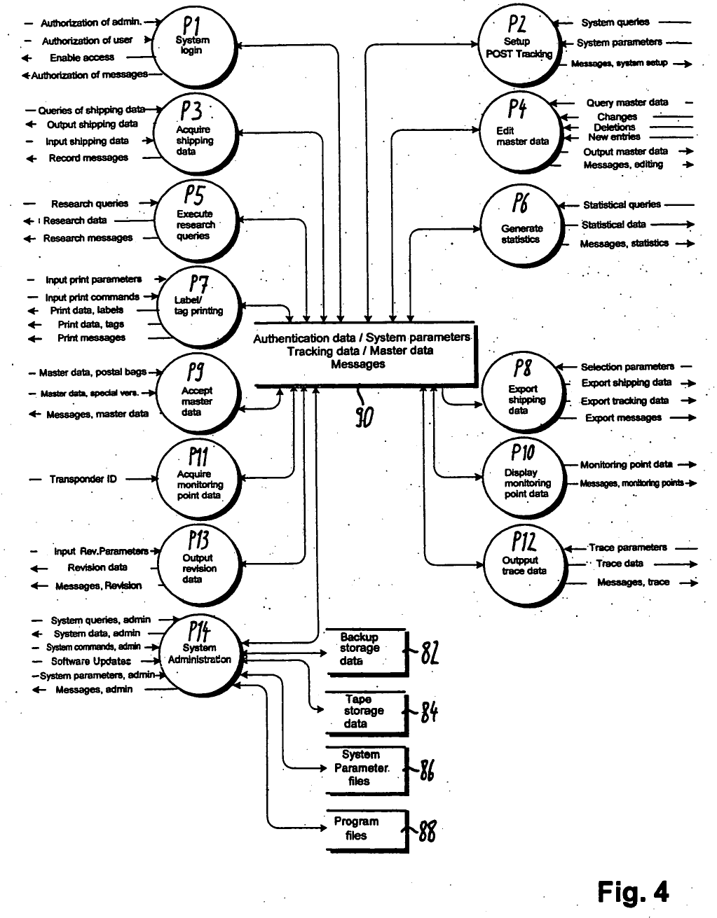

Various processes for implementation of the tracking of the postal bags 12a, 12b, 13a through 13j are shown in FIG. 4. The process P1 concerns the system login, whereby the process P1 depends on whether a user logs in with an administration authorization or with a user authorization, enables accesses associated with the respective authorization and initializes message authorizations that enable the messages transferred to the workstation (corresponding to the associated authorizations).

The process P2 concerns the setup of the postal tracking system, whereby the process P2 receives system queries as well as system parameters and outputs messages about the system setup. The process P3 concerns the identification of shipping data. Queries regarding shipping data are transmitted in the process P3 the process P3 thereupon outputs shipping data. Input shipping data are also supplied to the process P3 and the process P3 outputs messages about the identification of shipping data.

A process P4 concerns the handling (processing or editing) of master data. Queries of master data as well as changes, deletions and new entries of master data are transferred to the process P4. The process P4 outputs master data as well as messages for handling of the master data; in particular acknowledgements of changes, deletions and new entries.

A process P5 concerns a investigation process. Investigation queries are supplied to the process P5. The process P5 outputs investigation (research) data as well as messages regarding an investigation. A process P6 concerns the generation of statistics. The process P6 receives statistical queries and outputs statistical data as well as messages regarding the statistic or statistics to be generated.

A process P7 concerns the label/tag printing. Input print parameters as well as print commands are supplied in this process. The process P7 generates print data for label printing as well as print data for tag printing and outputs messages regarding printing, in particular production and error messages. Selection parameters for selection of the shipping data to be exported are supplied to a process P8 for exportation of shipping data. The process P8 generates the shipping data to be exported and outputs the generated shipping data. The process P8 also outputs the tracking data logged in the generation of the shipping data to be exported as well as messages for export of shipping data.

A process P9 concerns the acceptance (transfer) of master data. Master data from postal bags 12a, 12b, 13a through 13j as well as master data from special shipping goods are supplied in the process P9. The process P9 outputs messages for acceptance of the master data. The process P10 concerns the display of monitoring point data. The process P10 outputs monitoring point data as well as messages regarding individual monitoring points.

A process P11 concerns the identification of monitoring point data. The identification data of a transponder tag detected at the monitoring point are supplied to the process P11. A process P12 concerns the output of trace data. Output parameters for output of the trace data (in particular for selection of a portion of the logged trace data) are supplied to the process P12. The process P12 thereupon outputs corresponding trace data. The process P12 also outputs messages for registration and logging of events and processes, i.e. for tracing.

A process P13 concerns the output of revision data. Input revision parameters are supplied to the process P13. The process P13 thereupon generates revision data and outputs these. The process P13 also outputs messages regarding the revision. A process P14 concerns the system administration. System queries of the administrator are supplied to the process P14. Due to the system queries, the process P14 transfers system data to the administrator. The process P14 also receives system commands from the administrator as well as software updates and system parameters. The process P14 outputs messages, in particular system messages, to the administrator. The process P14 furthermore communicates with a backup institution 82 for storage of data, with a tape storage institution 84 for storage of data, with an institution 86 for administration of system parameter files and with an institution 88 for administration of program files. The processes P1 through P14 serve for administration of authorization data, system parameters, tracking data, master data and messages of the institution 90 that administers these data for the data system of the postal sortation site 10 according to FIG. 1. The processes P1 through P14 can, for example, be at least administered with the aid of the server 50 and be executed at least in part by this. The processes P1 through P14 generally describe the processes implemented in the postal sortation site for data administration and for data handling.

An automatic cost recording and cost association with cost centers can be implemented with the aid of the determination and association (described in FIGS. 1 through 4) of the quantity of postal bags 12a, 12b, 13a through 13j supplied to the postal sortation site 10. An absolute cost transparency is thereby possible. Both the sender and the receiver can be unambiguously determined via the automatic reading of the postal bag information, whereby the delivery quality and the delivery reliability can be continuously improved. The sortation throughput can in particular be increased via error notifications and elaborate determination of receivers. Transfer times from the arrival of the postal bags 12a, 12b, 13a through 13j at the postal sortation site 10 to the forwarding of the postal bags 12a, 12b, 13a through 13j from the postal sortation site 10 to a receiver can be protocolled without gaps. Weak points can in particular be determined and corrected via delivery and runtime evaluation. The manual investigation and address completion can be nearly completely omitted.

The determination and association of the quantity of shipping packages supplied to a sortation site can also advantageously be implemented with the aid of a method. An electronic data medium that can be read without contact, which data medium has at least one memory region in which at least data regarding the individual identification of the data medium are stored, is respectively associated with a plurality of shipping packages. A group of at least two groups is associated with each data medium. At least the data stored in the memory range of the respective data medium regarding its individual identification are recorded with the aid of a reader. The respective data medium is detected with the aid of the reader, whereby at least the detection process of the detected data of the data medium is identified. At least the number of the shipping packages supplied to the sortation site for a pre-definable time span is determined for at least one of the groups with the aid of the registered detection processes. The quantity of shipping packages to be associated with one of the groups can thus be determined in a simple manner. This in particular enables a cost association when a cost key is associated with the group.

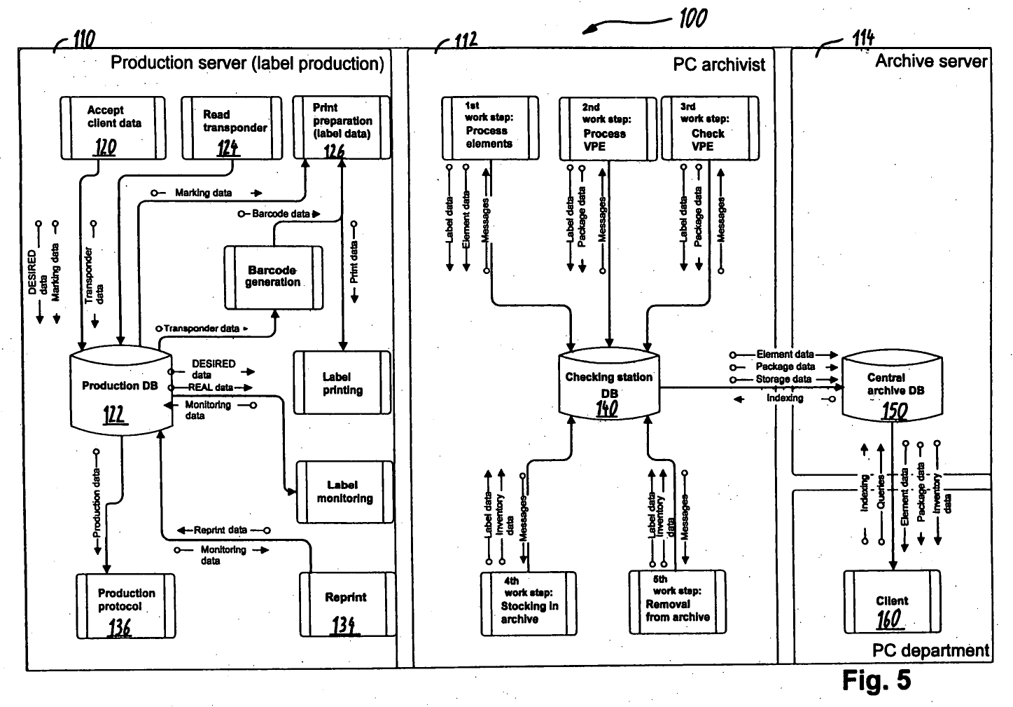

A system 100 for hierarchical archiving of storage units is shown in FIG. 5, in which storage units paper documents and/or data media are advantageously stored for archiving. The system 100 has a production server 110 for tag production, an archiving computer 112 for monitoring of the stocking and removal of the storage units in the archive or from the archive as well as an archive server 114 for administration of the data of the archived storage units. A process 120 for acceptance of client data is executed with the aid of the production server 110. Information about storage units and objects to be archived are contained in the client data to be accepted. These client data are accepted upon execution of the process 120 and stored as desired data and labeling data in a production databank 122.

The storage units respectively receive a self-adhesive tag in which an RFID transponder is contained or that is connected with an RFID transponder. As already mentioned in the preceding, such a tag is designated as a transponder tag. The transponder data of a provided transponder tag are read in a process 124. The read data are stored in the production databank 122. The labeling data stored in the production databank 122 are transferred to a print preparation process 126 for generation of print data. Transponder data and labeling data are also transferred from the production databank 122 to a barcode generation process 126. The print preparation process 126 generates print data from the supplied labeling data and barcode data, which print data are provided to a tag printing process 130. The transponder tags are printed with the aid of these print data.

The production databank 122 transfers to a tag monitoring process 132 the desired data and the real data of the data printed on a transponder tag as well as stored in the memory region of the transponder tag. The tag monitoring process 132 generates monitoring data and transfers these to the production databank 122. The production databank 122 transfers data for generation of reprinted transponder tags to a process 132 for reprinting of transponder tags. These data are also designated as reprint data. The process 134 transfers monitoring data about the reprinted transponder tags to the databank 122. The databank 122 transfers production data of the generated transponder tags to a protocol process 136.

In a first process for executing a first work step, an archiving computer 112 processes elements to be stocked or to be archived and transfers tag data and data regarding a first storage unit to be identified with the transponder tag to the checking station databank 140. The data regarding a first storage unit to be identified with the transponder tag are also designated as element data.

The databank 140 transmits messages about the occurred storage of the tag data and the element data to the process for implementation of the first work step. The tag data in particular comprise the data printed on the transponder tag and the data stored in the data medium of the transponder tag. The element data comprise information about the objects that are contained in the storage unit (identified with the transponder tag) for archiving. As already mentioned previously, these objects are in particular paper documents and/or data media. The element data advantageously comprise plain text comments for designation of the documents and/or data media contained in the respective storage unit.

A second process for execution of a second work step serves for preparation of packing units. First storage units are thereby provided in which are contained documents and/or data media to be archived. Second storage units are also provided that are likewise provided with transponder tags. The second storage units serve for acceptance of at least one first storage unit. In the present exemplary embodiment, the second storage units are designed such that they can accommodate up to five first storage units.

The first storage units are advantageously file folders in which paper documents and/or data media to be archived are filed. The second storage units are advantageously cartons in which, for example, up to five file folders with a back width of 80 mm can be packed, independent of the dimensions of the carton and the dimensions of the file folder to be archived. The first and second storage units are respectively provided with similar transponder tags. The transponder tags of the first storage units are associated with a first hierarchy and the transponder tags of the second storage units are associated with a second hierarchy. In the second work step, the first storage units to be packed in a second storage unit are associated with the second storage unit. In the checking station databank 140, the data contained in the transponder tags of the first storage units are thereby associated with the data contained in the transponder tags of the second storage unit. Packing units with first and second storage units are formed via this association.

A third process for execution of a third work step in which packing units are checked is subsequently executed. For this, both the data of the transponder tags of the first storage units contained in a second storage unit and the data of the transponder tag of the second storage unit are read and compared with the data stored in the checking station databank 140, which data have been generated in a second work step. An error message is output given deviations.

In a fourth process for implementation of a fourth work step, the second storage unit is stocked in an archive (advantageously in an archive container) together with the first storage units located inside said second storage unit. Upon stocking, the data of the transponder tags (the transponder tag data) of the second storage unit and of the first storage units located therein are read and stored in the databank 140. The determined transponder tag data are thereby compared with the association stored in the databank 140. Given deviations of the association (stored in the databank 140) of the first storage units with the second storage unit and the actual first storage units contained in the second storage unit, an error message (advantageously an acoustic error message) is output at a stocking station.

A fifth process for execution of a fifth work step is also provided in which second storage units are removed from the archive. Upon removal, both the transponder tag data of the second storage unit and the transponder tag data of the first storage units stored in the first storage unit are compared with the association stored in the databank 140. Given deviations, an error message is output. Upon stocking it is advantageously determined in which storage room or which container the second storage unit is stocked. A shelf space is advantageously determined in which the second storage unit is stocked, whereby the determined shelf space is stored in the databank 140. The transponders are electronic data media that can be read without contact and that advantageously can be read through the second storage unit serving as outer (secondary) packaging, such that the data of the first storage units can be read through the second storage unit. In particular data about stored first storage units, about the association of storage units contained in the second storage units, data about points in time of the stocking and removal as well as data for precise determination of the storage location of the second storage units are transferred from the databank 140 to a central archive databank 150.

Data for indexing of the objects contained in the first storage units are transferred from the central archive databank 150 to the checking station databank 140, via which information about the objects to be archived that are stored in the respective first storage units are supplied to the checking station databank 140. This information for indexing is transferred from a computer system 160 (connected with the central archive databank over a data line) to the central archive databank 150. The indexing is an association of code designations and/or keywords for designation of the objects to be archived in the storage units. The computer system 160 is advantageously connected with the central archive databank 150 via a network, in particular over a local area network. Databank queries are also transferred from the computer system 160 to the central archive databank 150, whereby the central archive databank 150 transfers data about stocked first and second storage units, about objects stocked in the first storage units and about further storage data, in particular stocking and removal times.

Data from a data medium associated with a person who stocks or removes the first and/or second storage units are advantageously recorded in the archive or from the archive with the aid of readers for identification of the stocked and/or removed first and/or second storage units. These data are likewise advantageously stored in one of the databanks 140, 150 and car, be retrieved with the aid of the computer system 160. A high transparency of the stockings and removals is thus provided and an incorrect association of the first and/or second storage units is avoided.

Before the removal of a first and/or second storage unit from the archive, this removal is advantageously approved for a predetermined personnel in at least one of the databanks 140, 150 with the aid of the computer system 160. This approval is advantageously limited to a preset time span. Given unauthorized or incorrect removal, an error message is then generated via which further actions are initiated according to the security model.

The association of a first storage unit with a second storage unit can occur either with the aid of a user interface in which an operating personnel assigns a first storage unit to the second storage unit or via reading of data of the transponder tags of the second storage unit and data of the transponder tags of the first storage units contained in the second storage unit or of the first storage units to be packed in the second storage unit. Due to the first hierarchies, the first storage units can only be associated with the second storage units associated with a second hierarchy. It is thereby prevented that first storage units are associated with other first storage units or that second storage units are associated with other second storage units. Errors in the association of first and second storage units are thereby effectively avoided. Data about the association of the first and second storage units are advantageously stored in memory ranges of the transponder tags of the first and/or second storage units in addition to the information stored in the databanks.

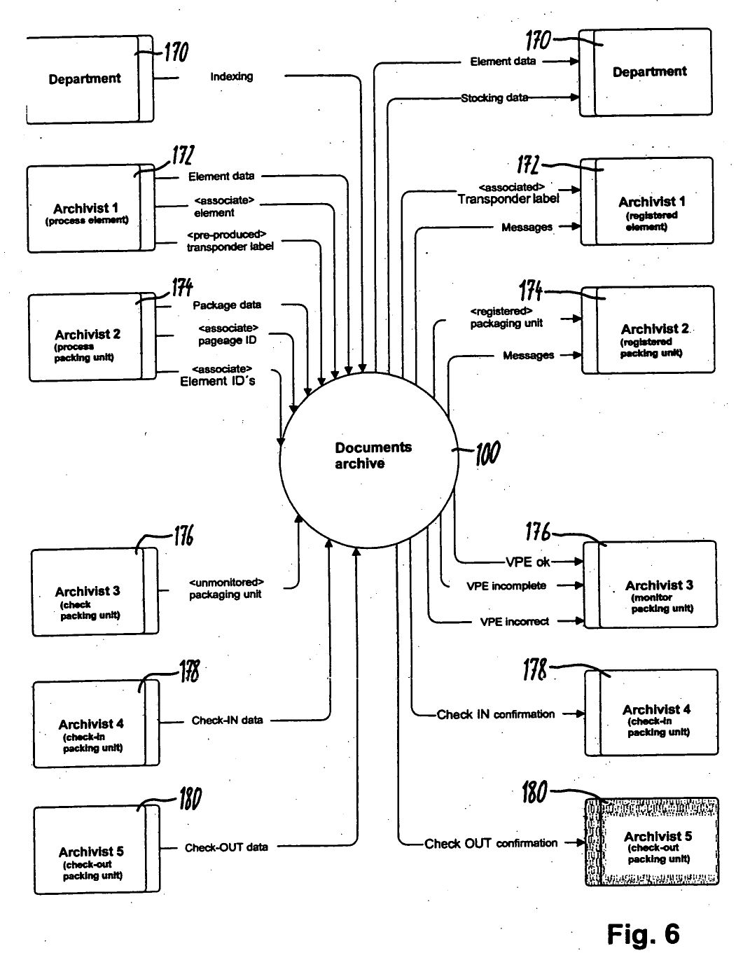

Institutions for archiving of first and second storage units are shown in FIG. 6 with the aid of the system 100 according to FIG. 5. The department 170 transfers information for indexing of the objects to be archived to the system 100. The document archive system 100 provides the department 170 with data about the first and second storage units in which the documents and data media to be archived are contained as well as storage data that concern the respective stocked first and second storage units. The storage data in particular comprise the point in time of the stocking and/or removal, personnel data of the person who conducted the stocking and/or removal as well as information regarding the stocking location, in particular a room number, container number and/or shelf number, via which the archiving location of the archived second storage unit is designated in more detail.

An institution 172 of an archivist 1 for handling of the storage units to be stocked establishes the data for identification of the transponder tags of the first and second storage units and associates the first storage units to be packed into a second storage unit with the second storage unit. The institution 172 of the archivist 1 also transmits to the system 100 information about an already pre-produced transponder tag whose transponder already possesses a readable identification value. A first storage unit is identified and associated with the aid of the institution 172 of the archivist 1. A pre-produced transponder tag is selected whose identification value is read out and transferred to the system 100. The system 100 associates the transferred identification value with the selected first storage unit and transfers data of the associated transponder tag as well as messages about the association to the institution 172 of the archivist 1.

An institution 172 of an archivist 2 identifies the second storage units and associates one transponder tag for each of these. The institution of the archivist 2 transfers data of the second storage unit to the system 100 and associates an identification value with the second storage unit. First storage units that should be accommodated by the second storage unit are also associated with the second storage unit. Data of these associations are transferred to the system 100. The system 100 registers these associations and transfers data about the registered second storage unit as well as messages about the registration to the institution 174 of the archivist 2. The second storage unit is also designated as packing and the first storage unit is also designated as an element in FIG. 6.

An institution 176 of an archivist 3 checks the second storage units and reads both the data contained in the transponder tags of the first storage units contained in the second storage unit and the data contained in the transponder tag of the second storage unit and respectively transfers these to the system 100. The system 100 checks the transferred data with the aid of the associations generated by the archivist 2. The system 100 transfers to the institution 176 of the archivist 3 the message that the checking of the second storage unit has yielded no errors, that the second storage unit is incomplete (i.e. that at least one first storage unit that is associated with this second storage unit is not contained in the second storage unit) or that the second storage unit contains an incorrect first storage unit, in particular a storage unit whose transponder identification value is not registered in the system 100 or that is associated with a different second storage unit.

An institution 178 of the archivist 4 serves for checking a second packing unit into an archive. The data of the checked-in second storage unit (and advantageously the data of the first storage units contained in the second storage unit to be checked in) are thereby identified. These data are transferred into the system 100. The system 100 transfers to the institution 178 of the archivist 4 the acknowledgement that the second storage unit has been successfully registered, i.e. successfully checked in. An institution 180 of an archivist 5 is also provided to check out a second storage unit. Upon checking out, the data of the checked-out second storage unit and, advantageously, additionally the data of the first storage units contained in the second storage unit to be checked out are registered and transferred to the system 100. Data of the person who removes the second storage unit from the archive are advantageously also identified. These data are additionally transferred to the system 100. The system 100 checks the data and registers the removal of the second storage unit from the archive and transfers a removal acknowledgement to the institution 180 of the archivist 5.

Both the first storage units and the second storage units contain transponder tags. The transponder of each transponder tag has an identification number (ID) that is unique at least for the archive system and that additionally is printed on the RFID transponder tag as a one-dimensional barcode, as a two-dimensional barcode and/or as plain text, such that the identification information of the corresponding first or second storage unit can also be determined with the aid of these identifiers. A high identification security of the first and second storage units is therewith provided. Information about the hierarchy level of the corresponding storage unit is also advantageously contained in this identification information. For example, the first storage units are provided with the identifier number 001 characterizing a first hierarchy level, and the second storage units are provided with the identifier number 010 characterizing a second hierarchy level. Storage units of a third hierarchy level are, for example, identified with the identifier number 100. Such third storage units are, for example, shelf space, shelf, container and/or archive rooms in which a plurality of second storage units are archived.

An RFID transponder is associated with each first storage unit, which RFID transponder is, for example, contained in a tag glued to the first storage unit. The first storage unit is advantageously a folder in which paper documents and/or data media are filed. An RFID transponder is also associated with each second storage unit, which RFID transponder is integrated in the same manner in a tag that is respectively glued on the second storage unit. Each RFID transponder tag has unique identification information that is stored in a central database, advantageously a databank. The RFID transponder tag identification information of the first storage units contained in a second storage unit are read in a read cycle for monitoring and tracking of at least the first storage units. This nearly simultaneous reading of the identification information of at least all first storage units contained in the second storage unit is also designated as what is known as bulk reading. During the read process, the identification information of the transponder tag of the second storage unit in which the first storage units are contained is additionally also identified. The database advantageously contains information as to which first storage units are contained in each of the second storage units and compares this stored information with the read information. An error signal is generated when the read information deviates from the stored information.

In one development, the hierarchical structure of the first storage units and the second storage units is mapped in the database. Information as to which cost base is in particular associated with a first storage unit is advantageously stored in the database or in the RFID transponder tag. This enables a precise itemization of the archiving costs to individual storage units.

An automated archiving of first storage units that respectively comprise an RFID transponder tag can be achieved with the aid of the archiving system shown in FIGS. 5 and 6. A plurality of these first storage units are packed into a second storage unit and form a packing unit together with the second storage unit. Given stocking and removal in an archive, both the information of the first storage units and the information of the second storage unit are identified via readout of the identification information from the respective RFID transponder tags and compared with stored information.

Via the use of RFID technology, closed second storage units can be used without these having to be opened given the identification of the identification information of the first storage units contained in the second storage unit. The second storage units can thereby in particular be sealed and stocked and removed in a sealed state, whereby the identification information of the second storage unit and that of first storage units contained in the second storage unit (which first units are not externally visible) can be identified both upon stocking and removal. The second storage units are advantageously cartons, boxes, palettes, containers that are made form a material through which the information contained in the RFID transponder tags can be read with the aid of a reader. The second storage units are advantageously not made from metal.

In the administration of the first packing units to be archived, the first packing units are defined and associated with a hierarchy level. Each of the first storage units also receives an RFID transponder which is associated with a unique identifier. This information is respectively stored in a data set of a databank, which data set is associated with a first storage unit. The second storage units are identified in the same manner, whereby an RFID transponder tag with unique identifier is also associated with these. The information regarding each of the second storage units is individually stored in a data set of the databank. A second hierarchy level is associated with the second storage units. The associated hierarchy level is stored in the data set of the respective second storage unit.

The first storage units to be stored in the second storage unit are subsequently assigned to this second storage unit. The information that these are associated with the corresponding second storage unit is respectively stored in the data sets of the first storage units to be stored in the second storage unit. Additionally, information as to which first storage units are associated with this second storage unit is stored in the data set of the second storage unit. At least one keyword-like item of information regarding the content of the archived elements, in particular regarding the content of the archived documents or data media, is additionally stored both with regard to the second storage unit and with regard to each of the first storage units.

Given the association of the first storage units with a second storage unit, the hierarchy level associated with a storage unit is respectively taken into account so that only first storage units (and no further second storage units) can be associated with a second storage unit. A first storage unit can also be associated with no other first storage units and no second storage units. In the association, storage units of a lower hierarchy level are thus automatically associated with storage units of a higher hierarchy level. Further hierarchy levels can be provided, for example a third hierarchy level for a palette for acceptance of second storage units that can then be associated with a fourth storage unit (in particular a container) that is associated with a fourth hierarchy level. The associated hierarchy levels are advantageously contained in an encrypted form in the identification information of the transponder tag associated with the storage unit.

A check as to whether the first storage units associated with a second storage unit are actually contained in the second storage unit is implemented upon stocking or removal. For this, all identification information of the RFID transponder tags of the second storage unit and of the first storage units contained in the second storage unit is read in what is known as a bulk read process. The check can lead to the following results:

1. The identified identification information agrees one-hundred percent with the association stored in the databank.

2. 1 to n of the identified identification information items of the first packing units associated with the second storage unit are not in the databank.

3. 1 to n first storage units are missing in the second storage unit relative to the association stored in the databank.

Archived objects can be sought and found in the archive with the aid of the information stored in the databank, in particular with the aid of the keyword information stored with regard to each first and each second storage unit.

Error rates can be significantly reduced via this archiving system, in particular via the hierarchical organization of the first and second storage units. The use of the RFID transponder tags also has the advantage that, given the stocking and given the removal, seals provided on the second packing units do not have to be opened to check the first storage units contained in the second storage unit. Via the bulk read processes, in which both the identification information of a second storage unit and the identification information of the first storage units can be read essentially simultaneously, a significant time savings can also be achieved relative to an individual identification of the first storage units.

The hierarchical archiving of storage units can advantageously be implemented with the aid of a method in which respectively at least one object to be archived is archived in multiple first storage units. An electronic data medium that can be read without contact is associated with each of the first storage units. A first identifier of a first hierarchy is associated with each of these data media. At least data for individual identification of the respective data medium is stored in a recording medium of the data medium. A first storage unit or a plurality of first storage units are respectively accommodated in the second storage units for archiving. An electronic data medium that can be read without contact and with which a second identifier of a second hierarchy is associated is respectively associated with the second storage units. At least data for individual identification of the respective data medium are stored in the memory range of the respective data medium. At least the data for individual identification of the data medium, which data is stored in the respective data medium, are read without contact with the aid of a reader. A second storage unit is supplied to the reader with the first storage units contained in the second storage unit, via which both data from the data medium of the second storage unit and data from the data media of all first storage units contained in the second storage unit are identified. Information of a second storage unit and of the first storage units contained in the second storage unit or to be accepted by this are respectively stored in a databank. The data acquired during the read cycle of the reader are checked with the aid of the association stored in the databank.

The effort for archiving of first storage units is significantly reduced with the aid of such a method, in particular when the first storage units for archiving should be packed in the second storage units.

It is, for example, known from the documents DE 197 20 747 A and U.S. Pat. No. 6,738,689 B2 to use RFID transponders for monitoring of postal shipments. Methods and device systems for generation and tracking of printed documents are known from the document WO 03/0977196 A1, in which a unique identifier that is stored in an RFID transponder connected with the document is associated with each document. Arrangements and methods for shipment tracking, advantageously for monitoring of a supply chain, are known from the documents EP 1 189 163 A2, U.S. Pat. Nos. 6,843,415 B2, 2003/0227392 A1. Hierarchical organization structures for organization of objects connected with RFID tags are known from the document WO 2004/102330 A2 and from the document “Cascading RFID-Tags”, Jeffrey D. Lindsay and Walter Ready, Nov. 7, 2003, http://www.jefflindsay.com/rfid3.shtml. The content of the cited documents (in particular the RFID transponder technology described there, the infrastructure for reading and writing the RFID transponders and the infrastructure for administration of the read data and the data to be written) is herewith incorporated by reference into the disclosure of the present specification. The features of the methods and arrangements described there can be combined individually or in combination with the features disclosed in this application.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

We claim as our invention:

1. An arrangement for identification and association of a quantity of shipping packages supplied to a postal sortation site, comprising:
multiple shipping packages that respectively comprise an electronic data medium that can be read without contact and that has at least one memory region in which at least data for individual identification of the data medium are stored, each data medium being associated with one of at least two groups;
a reader for acquisition of at least the data stored in the memory region of the respective data medium regarding its individual identification;
a data processing unit that identifies the respective data medium with aid of the acquired data and at least registers an acquisition of the identified data of the data medium; and
the data processing unit, with aid of the registered acquisition process, determining at least a number of the shipping packages supplied to the sortation site for a predeterminable time span for at least one of the groups.

2. An arrangement according to claim 1 wherein the data processing unit registers the acquisition process of the data by determining the group associated with said data medium and changes a count value of a counter associated with the determined group given each registering of a data medium associated with said group, or stores an acquisition process associated with the data medium in a databank associated with the data medium.

3. An arrangement according to claim 1 wherein the data processing unit records the number of the shipping packages associated with a group.

4. An arrangement according to claim 1 wherein the arrangement comprises a databank in which is advantageously stored at least one data set regarding each data medium, in which data set are contained at least one part of the information stored as data in the memory region of the respective data medium, and the data processing unit, with aid of the information contained in the data set associated with the respective data medium, determining the group with which the data medium is associated.

5. An arrangement according to claim 4 wherein a unique identification code with which a group is associated is stored in the memory region of each data medium, a plurality of data media or a plurality of identification codes being associated with the same group.

6. An arrangement according to claim 1 wherein the shipping packages respectively contain a paper document or a plurality of paper documents with respectively at least one single sheet, and the shipping packages are a reusable, re-sealable mailer, at least one part of the paper documents being respectively enveloped.

7. An arrangement according to claim 1 wherein the data media can be read electronically with a transponder based on RFID technology, the transponder being connected with a printable tag or contained in a printable tag.

8. An arrangement according to claim 1 wherein the shipping packages are characterized with aid of external differentiating features for characterization of a shipment type contained in the respective shipping package, the shipment types in particular differentiating check shipments, remittance shipments, organization-internal mail shipments, or external mail shipments, and the data processing unit separately recording a number of a group of associated shipping packages for each shipment type.

9. An arrangement according to claim 1 wherein the arrangement comprises an outer packaging for acceptance of a plurality of shipping packages and, during a read cycle, the reader reads data from the data media of all shipping packages associated with an outer packaging, the outer packaging advantageously comprising a container.

10. An arrangement according to claim 9 wherein the reader reads at least one part of the data stored in the respective data medium before shipment of the outer packaging to a receiver, the data processing unit determining the receiver of all shipping packages associated with the outer packaging and checking whether all shipping packages are to be sent to the same receiver, and the data processing unit, in the determination of the number of the shipping packages supplied to the reader for a pre-definable time span, does not also take into account the read processes for checking the receiver before the shipment.

11. An arrangement according to claim 1 wherein the data processing unit records the time of arrival of the shipping package at the reader as an input time or as an output time of the shipping package in or at the sortation site.

12. An arrangement according to claim 1 wherein a first sender is associated with the first group of the at least two groups and a second sender is associated with the second group, or a cost center is associated with the first group and a second cost center is associated with the second group.

13. An arrangement for hierarchical archiving of storage units, comprising:
a plurality of first storage units in which respectively at least one object to be archived is contained, each of the first storage units comprising an electronic data medium that can be read without contact and with which is associated a first identifier of a first hierarchy, and in a memory region thereof at least data for individual identification of the respective data medium are stored;
a plurality of second storage units for acceptance of a first storage unit or a plurality of first storage units, the second storage units respectively comprising an electronic data medium that can be read without contact and with which is associated a second identifier of a second hierarchy, and in a memory region of which at least data for individual identification of the respective data medium are stored;
a reader for reading without contact at least the data stored in the respective data medium regarding its individual identification;
after the supply of a second storage unit, during a read cycle the reader records both data from the data medium of the second storage unit and data from the data media of all first storage units contained in the second storage unit;
a databank in which respective information is stored of an association of the first storage units contained in a second storage unit or to be accommodated by it; and
a data processing unit that checks the association stored in the databank with aid of data acquired during a read cycle.

14. An arrangement according to claim 13 wherein the data processing unit advantageously outputs an error message when the association recorded with aid of the reader does not coincide with the association stored in the databank.

15. An arrangement according to claim 13 wherein the data processing unit, in an acquisition mode, detects at the second storage unit an association of all first storage units contained in the second storage unit and stores the acquired association in a databank, in a monitoring mode the databank checking the association detected in the acquisition mode with aid of the data acquired during a further read cycle.

16. An arrangement according to claim 13 wherein the association of the first storage unit or of the first storage units with the second storage unit occurs via an association in the databank, a maximal number of first storage units that can be associated with the second storage unit being a number that it can accommodate.

17. An arrangement according to claim 15 wherein the data processing unit implements the association of the first storage units contained in the second storage unit with the second storage unit at least for each of the second storage units that contain at least one of the first storage units.

18. An arrangement according to claim 13 wherein the reader or at least one further reader acquires at least data for individual identification of the data medium of the second storage unit and at least data for individual identification of the data stored in the data media of the first storage unit contained in the second storage unit, at least upon stocking of the second storage unit in the archive or upon removal of the second storage unit from the archive.

19. An arrangement according to claim 18 wherein the data processing unit checks whether the data for individual identification of the data media of the first and second storage units coincides with the association stored in the databank.

20. An arrangement according to claim 13 wherein at least the second storage units can be sealed into a closed outer packaging.

21. An arrangement according to claim 13 wherein a reader comprises a read unit for reading of the first data medium and for reading of the second data medium, or a first read unit for reading of the first data medium and a second read unit for reading of the second data medium.

22. An arrangement according to claim 13 wherein the arrangement has at least one writer for storage of data on the first or second data medium, whereby the writer writes data of a time stamp upon stocking or upon removal of the second storage unit in at least one memory range of at least the data medium of the second storage unit.

23. An arrangement according to claim 13 wherein the arrangement comprises at least one third storage unit for accommodation of a plurality of second storage units: the third storage unit comprising an electronic data medium that can be read without contact and with which a third identifier of a third hierarchy is associated, and in memory region of which are stored at least data for individual identification of the respective data medium; the third storage unit being arranged in a fourth storage unit with further storage units exhibiting the third identifier and with said fourth identifier a fourth hierarchy level is associated; and the fourth storage unit comprising a container.

24. An arrangement according to claim 13 wherein given stocking of a second storage unit in the archive or in the third storage unit or upon removal of the second storage unit from the archive or from the third storage unit, the reader acquires data stored in a memory region of an electronic data medium that is associated with a person, in that at least data for individual identification of the respective data medium are stored; and wherein the data processing system stores information for identification of the data medium or the person in the databank with time information regarding a stocking point in time or removal point in time.

25. An arrangement according to claim 23 wherein the third storage unit is accessible by a person, and is a container provided with shelves for storage of second storage units, the second storage units respectively comprising a carton in which at least one file folder serving as a first storage unit is contained.

26. An arrangement according to claim 13 wherein in addition to the data medium, the first, the second or third storage units comprise at least information for individual identification of the respective storage units.

27. An arrangement according to claim 13 wherein the first storage unit contains a plurality of single sheets, and the first storage unit additionally contains a further data medium with data to be archived.

28. A method for identification and association of a quantity of shipping packages supplied to a postal sortation site, comprising the steps of:
associating with multiple shipping packages an electronic data medium that can be read without contact and that has at least one memory region in which at least data for individual identification of the data medium are stored;
associating with each data medium one of at least two groups;
acquiring with a reader at least the data stored in the memory region of the respective data medium regarding its individual identification;
identifying the respective data medium with the acquired data;
registering at least an acquisition process of the identified data of the data medium; and
determining at least a number of the shipping packages supplied to the sortation site for a predeterminable time span for at least one of the groups with aid of the registered acquisition processes.

29. A method for hierarchical archiving of storage units, comprising the steps of:
archiving at least one respective object to be archived in a plurality of first storage units;
associating with each of the first storage units an electronic data medium that can be read without contact;
associating a first identifier of a first hierarchy with each of these data media;
storing in a memory region of the data medium at least data regarding the individual identification of the respective data medium;
accommodating in second storage units for archiving a first storage unit or a plurality of respective first storage units;
respectively associating with the second storage units an electronic data medium that can be read without contact and with said data medium associating a second identifier of a second hierarchy;
storing at least data for individual identification of the respective data medium in the memory region of the respective data medium;
reading without contact with a reader at least the data stored in the respective data medium for individual identification of the data medium;
supplying a second storage unit to the reader with the fist storage units contained in the second storage unit;
via said reader acquiring both data from the data medium of the second storage unit and data from the data media of all first storage units contained in the second storage unit;
respectively storing in a databank information of a second storage unit and of the first storage units contained in the second storage unit or first storage units to be accommodated by the second storage unit in which the data acquired during the read cycle of the reader are checked with the association in the databank.
